(19) United States
(12) Patent Application Publication
(10) Pub. No.: US 2026/0080292 A1
(43) Pub. Date: Mar. 19, 2026

(54) DESIGNING DYNAMICALLY CORRECTED GATES ROBUST TO MULTIPLE NOISE SOURCES USING GEOMETRIC SPACE CURVES

(71) Applicant: VIRGINIA TECH INTELLECTUAL PROPERTIES, INC., Blacksburg, VA (US)

(72) Inventors: Edwin Barnes, Blacksburg, VA (US); Hunter Nelson, Blacksburg, VA (US); Evangelos Piliouras, Blacksburg, VA (US)

(21) Appl. No.: 18/793,224

(22) Filed: Aug. 2, 2024

Related U.S. Application Data
(60) Provisional application No. 63/517,220, filed on Aug. 2, 2023.
(60) Provisional application No. 63/518,213, filed on Aug. 8, 2023.

(51) Int. Cl. G06N 10/70; G06N 10/20

(52) U.S. Cl. CPC G06N 10/70; G06N 10/20

(57) ABSTRACT

Embodiments directed to designing corrective control signals are described. When implemented to drive a quantum operation, such corrective control signals can implement quantum gates that are insensitive to different noise types associated with the quantum operation. In one example, a method can include deriving noise cancellation conditions that are to be satisfied to define a corrective control signal that cancels different noise types associated with performing a quantum operation when the corrective control signal is used to drive the quantum operation. The method can further include constructing a space curve that satisfies the noise cancellation conditions in a multidimensional space. The space curve can be representative of the corrective control signal. The method can further include defining the corrective control signal based on the space curve.

### CROSS REFERENCE TO RELATED APPLICATIONS

This application claims the benefit of and priority to U.S. Provisional Application Ser. No. 63/517,220, filed Aug. 2, 2023, titled “DESIGNING DYNAMICALLY CORRECTED GATES ROBUST TO MULTIPLE NOISE SOURCES USING GEOMETRIC SPACE CURVES,” the entire contents of which are hereby incorporated herein by reference. This application further claims the benefit of and priority to U.S. Provisional Application Ser. No. 63/518,213, filed Aug. 8, 2023, titled “DESIGNING DYNAMICALLY CORRECTED GATES ROBUST TO MULTIPLE NOISE SOURCES USING GEOMETRIC SPACE CURVES,” the entire contents of which are hereby incorporated herein by reference.

### BACKGROUND

Quantum computing utilizes quantum mechanics to solve complex problems that “classical” computers, including supercomputers, cannot easily solve. Quantum computing devices solve such problems by performing operations on one or more quantum bits (“qubits”), which are used as the basic units of information in quantum computing operations and are analogous to “bits” used in classical computing. However, unlike a classical bit that exists in either one of two states (i.e., 0 or 1), a qubit can exist in a superposition of these two states (i.e., both 0 and 1).

A quantum evolution is an operation performed on a qubit. Initially, the qubit is sitting in some initial state, and it will rotate in some way in response to a control pulse. The rotation can be affected by noise such that the qubit will rotate in some unexpected manner in completing the operation, producing noise-induced quantum gate errors. Noise-induced quantum gate errors remain one of the main obstacles to realizing a broader range of quantum information technologies using quantum computing devices. Dynamical error suppression using carefully designed control schemes is an approach used to overcome quantum gate errors. Dynamical error suppression schemes can help to compensate for the noise and quantum gate errors afflicting qubits to reach error correction thresholds.

### SUMMARY

The present disclosure is directed to designing corrective control signals that, when implemented to drive a quantum operation, yield quantum gates that are insensitive to different noise types associated with the quantum operation. More specifically, described herein is an extension of a Space Curve Quantum Control (SCQC) formalism that uses geometric space curves to design quantum gates that are insensitive to a certain type of noise associated with a quantum operation. In particular, the present disclosure describes an extended SCQC framework that leverages and expands the SCQC formalism by using geometric space curves to design quantum gates that are insensitive to multiple, different types of noise associated with a quantum operation.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

In one example embodiment, a method is described for defining a control signal that cancels multiple noise types in a quantum computing device. The method includes deriving, by a computing device, noise cancellation conditions that are to be satisfied to define a corrective control signal that cancels different noise types associated with performing a quantum operation when the corrective control signal is used to drive the quantum operation. The method further includes constructing, by the computing device, a space curve that satisfies the noise cancellation conditions in a multidimensional space. The space curve being representative of the corrective control signal. The method further includes defining, by the computing device, the corrective control signal based on the space curve.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a block diagram of an example environment according to at least one embodiment of the present disclosure.

FIG. 2A illustrates a diagram of an example space curve according to at least one embodiment of the present disclosure.

FIG. 2B illustrates a diagram of example control fields according to at least one embodiment of the present disclosure.

FIG. 2C illustrates a diagram of example gate infidelities according to at least one embodiment of the present disclosure.

FIG. 3A illustrates a diagram of another example space curve according to at least one embodiment of the present disclosure.

FIG. 3B illustrates a diagram of additional example control fields according to at least one embodiment of the present disclosure.

FIG. 3C illustrates a diagram of additional example gate infidelities according to at least one embodiment of the present disclosure.

FIG. 4A illustrates a diagram of an example tangent curve according to at least one embodiment of the present disclosure.

FIG. 4B illustrates a diagram of another example space curve according to at least one embodiment of the present disclosure.

FIG. 4C illustrates a diagram of additional example control fields according to at least one embodiment of the present disclosure.

FIG. 4D illustrates a diagram of additional example gate infidelities according to at least one embodiment of the present disclosure.

FIG. 5 illustrates a flow diagram of an example computer-implemented method according to at least one embodiment of the present disclosure.

### DETAILED DESCRIPTION

In general, implementation of a control signal that drives a quantum operation or a quantum evolution (i.e., a quantum operation performed on a qubit) involves designing a pulse shape, generating a pulse having the pulse shape, and sending the pulse into a quantum computing device. However, due to random fluctuations in the pulse caused by the electronics used to generate and transmit the pulse, by the time the pulse reaches the device, it has some degree of deformation or variation compared to when it was transmitted. This deformation or variation in the pulse cannot be controlled or corrected after the pulse has been transmitted, and thus, it becomes control field noise that afflicts the qubit during the operation, resulting in noise-induced quantum gate errors. Additionally, interaction of a qubit with its surrounding environment creates transverse dephasing noise that also afflicts the qubit during the operation, thereby exacerbating such noise-induced quantum gate errors.

The embodiments described herein use and expand upon a Space Curve Quantum Control (SCQC) formalism to design quantum gates that are insensitive to a certain type of noise associated with a quantum operation. The SCQC formalism, which is leveraged and expanded by the extended SCQC framework described herein, is a mathematical construct that can be used to solve problems of how to cancel noise associated with performing quantum operations. The SCQC formalism involves mapping the dynamics of a quantum system into a geometric description represented as a space curve. By imposing certain geometric constraints on the shape of the space curve, the SCQC formalism can be used to realize different effects on the quantum system. For instance, the SCQC formalism can be used to implement certain types of quantum operations, cancel noise, and help to ensure that control signals (e.g., pulses, waveforms) sent into the quantum system will have certain desired properties (e.g., parameters, control fields). When the geometric constraints are satisfied for a particular space curve, the properties of a control signal can then be extracted from the space curve, and the control signal can be generated using such extracted properties.

Other control formalisms have allowed only for the cancellation of transverse dephasing noise. However, in most qubit platforms (e.g., quantum dot spin qubits, superconducting transmons, and trapped ions), the control field noise described above is of comparable importance. The present disclosure provides solutions to address the above-described problems associated with noise-induced quantum gate errors in general and with respect to the previous application of SCQC and other formalisms. For example, the extended SCQC framework described herein can be implemented to design a pulse having a desired pulse shape that allows for a resulting quantum gate to be insensitive to control field noise (i.e., noise caused by the fluctuations in the pulse) and transverse dephasing noise (i.e., noise caused by a qubit interacting with its surrounding environment).

The extended SCQC framework described herein is a general framework for designing control fields that simultaneously suppress both noise in the control fields themselves and transverse dephasing noise. Using the SCQC formalism, in which robust quantum evolution is mapped to closed geometric curves in a multidimensional Euclidean space, the extended SCQC framework can be used to derive noise cancellation conditions that guarantee the cancellation of both types of noise to leading order. Additionally, the extended SCQC framework described herein provides techniques for solving such noise cancellation conditions and also provides examples of error-resistant control fields that can be defined using the extended SCQC framework.

The extended SCQC framework of the present disclosure provides several technical benefits and advantages. For example, the extended SCQC framework is agnostic to the quantum platform in which it is used. Thus, the extended SCQC framework can be implemented to design dynamically corrected quantum gates that are insensitive to different noise types associated with any type of qubit system. Additionally, the extended SCQC framework can be implemented to custom design such dynamically corrected quantum gates for a particular quantum system or operation.

Accordingly, the extended SCQC framework can be implemented to design dynamically corrected quantum gates that are insensitive to different noise types associated with various quantum systems and operations, thereby allowing for relatively more accurate quantum information to be extracted from such systems compared to existing approaches. In this way, the extended SCQC framework can reduce the time and costs (e.g., computational costs) associated with achieving error correction thresholds for various types of quantum operations across a range of different quantum platforms. Through the facilitation of error correction thresholds, the extended SCQC framework can also contribute to realizing a broad range of quantum information technologies.

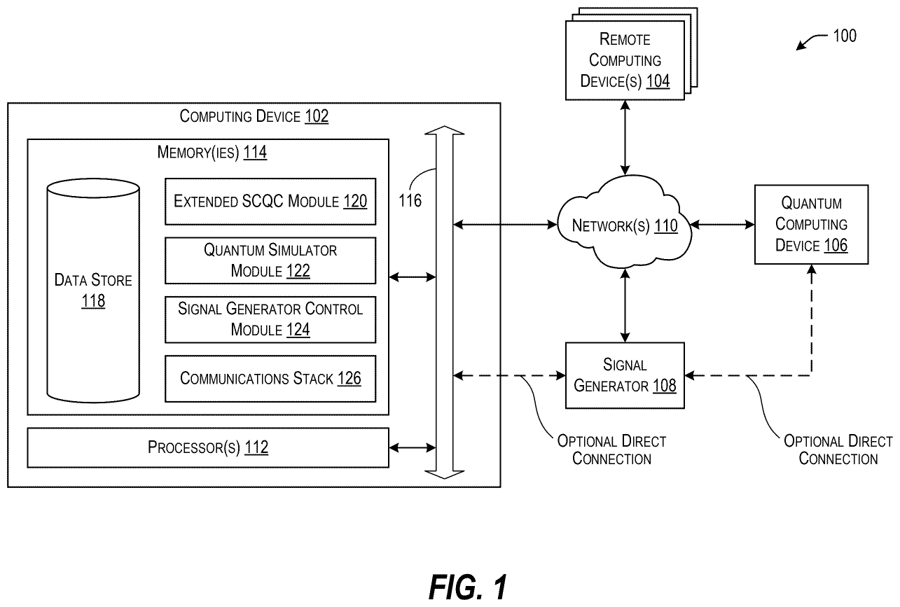

For context, FIG. 1 illustrates a block diagram of an example environment 100 according to at least one embodiment of the present disclosure. The environment 100 can be a computing environment in which classical and quantum computing operations can be performed, among other operations. The environment 100 is illustrated as a representative example, and the extended SCQC framework concepts described herein are not limited to use with any particular type of computing environment.

In the example illustrated in FIG. 1, the environment 100 includes a computing device 102, one or more remote computing devices 104 (collectively, “remote computing devices 104”), a quantum computing device 106, and a signal generator 108, among other components. In this example, the computing device 102, the remote computing devices 104, the quantum computing device 106, and the signal generator 108 are coupled to one another by way of one or more networks 110 (collectively, “networks 110”). In some examples, the computing device 102 can be directly coupled to the signal generator 108, which can be directly coupled to the quantum computing device 106. Such direct coupling can be achieved by way of a wired connection or another connection that can allow for at least one of a communicative, electrical, operative, or optical coupling of the computing device 102 to the signal generator 108 and coupling of the signal generator 108 to the quantum computing device 106. In one example, such direct coupling can be achieved by way of one or more coaxial cables.

The computing device 102 and any or all of the remote computing devices 104 can each be embodied or implemented as, for example, at least one of a server computing device, a client computing device, a general-purpose computer, a special-purpose computer, a virtual machine, a supercomputer, a laptop, a tablet, a smartphone, or another type of computing device that can be configured and operable to perform various operations described herein. A detailed description of the computing device 102 and the operations it can perform is provided below.

The quantum computing device 106 can be embodied or implemented as, for example, a qubit-based quantum computing device that can be configured and operable to perform quantum operations involving one or more qubits. For instance, the quantum computing device 106 can be embodied or implemented as at least one of a superconducting qubit device, a quantum dot spin qubit device, a superconducting transmons device, a trapped ions device, or another qubit device that can be configured and operable to perform quantum operations involving one or more qubits. Examples of such quantum operations can include, but are not limited to, at least one of a quantum or qubit evolution, a quantum or qubit operation, a quantum or qubit gate operation, a single-qubit gate operation, or another quantum operation.

The signal generator 108 can be embodied or implemented as, for example, a pulse generator that can be configured and operable to generate various signals or pulses that can be used to perform various operations associated with the quantum computing device 106. For instance, the signal generator 108 can generate control signals or pulses that can be used to drive quantum operations performed by the quantum computing device 106. In one example, the signal generator 108 can be embodied or implemented as a microwave pulse generator configured to generate resonant microwave pulses. The resonant microwave pulses can drive quantum operations performed by the quantum computing device 106.

The networks 110 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The computing device 102, the remote computing devices 104, the quantum computing device 106, and the signal generator 108 can communicate data with one another over the networks 110 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 110, without limitation. Although not illustrated, the networks 110 can also include connections to any number of other network hosts, such as website servers, file servers, networked computing resources, databases, data stores, or other network or computing architectures in some cases.

Among other types of control signals, the computing device 102 can be configured to design and generate corrective control signals. As one example, the computing device 102 can generate a corrective control signal that cancels noise associated with performing quantum operations. For instance, the computing device 102 can design a corrective control signal including or yielding control fields that generate a dynamically corrected quantum gate (e.g., qubit gate) that is insensitive to different types of noise associated with a quantum operation. Additionally, the computing device 102 can design a corrective control signal such that it can simultaneously cancel different types of noise associated with a quantum operation. In this way, it should therefore be appreciated that the operation of the quantum computing device 106 to perform a quantum operation based on a corrective control signal described herein also results in the cancellation, reduction, or avoidance of such different noise types in the quantum computing device 106. Examples of such different noise types include, but are not limited to, at least one of an additive noise type, a multiplicative noise type, transverse dephasing noise (i.e., the noise resulting from a qubit interacting with its surrounding environment), control field noise (i.e., the noise resulting from fluctuations in a control pulse sent into a quantum computing device), or another noise type.

In designing such a corrective control signal, the computing device 102 can account for the quantum related aspects (e.g., quantum dynamics, features, or properties) of a particular quantum computing device that can create or contribute to certain noise types during a quantum operation. Additionally, in designing such a corrective control signal, the computing device 102 can also account for the quantum related aspects (e.g., quantum dynamics, features, or properties) associated with a particular quantum operation to be performed. In this way, the computing device 102 can custom design various corrective control signals that can each be implemented to simultaneously cancel different noise types associated with a certain quantum operation performed by a particular quantum computing device.

In one example, to design such a corrective control signal described above, the computing device 102 can implement a method that leverages geometric space curves to design a quantum gate that is robust (i.e., insensitive) to at least the different noise types noted above. For instance, the computing device 102 can implement any or all of the methodologies, equations, theorems, and SCQC formalism described in examples herein.

As described herein, the computing device 102 is configured to define a control signal for a quantum operation based on a set of conditions. The conditions can include noise cancellation conditions (e.g., conditions leading or resulting in the cancellation of noise), in one example, although the conditions can be related to other operating aspects of qubits, quantum gates, or quantum operations. The noise cancellation conditions can be defined by quantum dynamic conditions, mathematical conditions, geometric conditions, or other conditions that may lead to the cancellation of or avoidance of noise in quantum computing devices. In that context, it should be appreciated that the operating conditions or parameters leading to the cancellation or avoidance of noise in a first type of quantum computing device can vary as compared to those resulting in the cancellation of noise in a second, different type of quantum computing device. Thus, the computing device 102 is also configured to derive or determine the set of conditions from which control signals are ultimately defined. The computing device 102 can derive or define the conditions based on operating characteristics or other information related to the quantum computing device 106, the signal generator 108, and other information.

To arrive at a quantum gate, for example, that is insensitive to different noise types according to the embodiments, the computing device 102 can derive noise cancellation conditions that are to be satisfied to define a corrective control signal that can simultaneously cancel different noise types when used to drive a quantum operation. In these examples, the computing device 102 can further construct a space curve that satisfies the noise cancellation conditions in a multidimensional space, where the space curve is representative of the corrective control signal. In these examples, the computing device 102 can then use the space curve to define or configure the corrective control signal. For instance, as the space curve is representative of the corrective control signal, the computing device 102 can translate geometric characteristics (e.g., curvature and torsion characteristics) of the space curve into properties (e.g., parameters, control fields) of the corrective control signal.

The noise cancellation conditions noted above can be indicative of certain quantum dynamics conditions involved with performing a quantum operation that, when satisfied, will allow for a control signal used to drive the operation to simultaneously cancel different noise types. The noise cancellation conditions can be described mathematically and can be represented graphically as a space curve in a multidimensional space (e.g., a Euclidean space). Accordingly, the noise cancellation conditions noted above can include, be indicative of, correspond to, or otherwise be associated with at least one of quantum dynamics conditions, mathematical conditions, geometric conditions, or other conditions in some cases. Any control signal extracted (i.e., defined, configured, translated) from a space curve that satisfies the noise cancellation conditions described herein can simultaneously cancel both transverse dephasing noise and control field noise when implemented to drive a quantum operation.

In one example, the noise cancellation conditions can include a geometric condition requiring a space curve to be a closed curve. As another example, the noise cancellation conditions can include a geometric condition requiring a derivative of a space curve to satisfy a zero-area condition. In another example, the noise cancellation conditions can include geometric conditions requiring a space curve to be a closed curve and a derivative of the space curve to have zero area. Any control signal extracted (i.e., defined, configured, translated) from a space curve that satisfies both of such geometric conditions can simultaneously cancel both transverse dephasing noise and control field noise when implemented to drive a quantum operation. The derivative of a space curve noted above is a tangent curve that can be obtained by projecting the space curve onto three orthogonal planes in a multidimensional space (e.g., a Euclidean space). The zero-area condition requires such a tangent curve to have zero area. In particular, the zero-area condition requires each of the three projections of the space curve noted above to have zero area.

To design a quantum gate that is insensitive (i.e., robust) to different noise types as described above, the computing device 102 can include at least one processing and memory system. In the example depicted in FIG. 1, the computing device 102 includes at least one processor 112 and at least one memory 114, both of which are communicatively coupled, operatively coupled, or both, to a local interface 116. The memory 114 includes a data store 118, an extended Space Curve Quantum Control (SCQC) module 120 (“extended SCQC module 120”), a quantum simulator module 122, a signal generator control module 124, and a communications stack 126 in the example shown. The computing device 102 is coupled to the networks 110 by way of the local interface 116 in this example. In some cases, the computing device 102 can be coupled to the signal generator 108, in addition to or in place of the networks 110, by way of the local interface 116. The computing device 102 can also include other components that are not illustrated in FIG. 1.

The processor 112 can be embodied as or include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 112 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 114 can be embodied as one or more memory devices and can store data and software or executable-code components executable by the processor 112. For example, the memory 114 can store executable-code components associated with the extended SCQC module 120, the quantum simulator module 122, the signal generator control module 124, and the communications stack 126 for execution by the processor 112. The memory 114 can also store data such as the data described below that can be stored in the data store 118, among other data. For instance, the memory 114 can also store data indicative of the quantum related aspects (e.g., quantum dynamics, features, or properties) associated with various quantum computing devices or quantum operations to be performed, data indicative of one or more corrective control signals or corrective control fields that have been previously defined as described herein, and/or data indicative of empirical or simulated test results obtained from implementing or simulating such corrective control signal(s) or field(s).

The memory 114 can store other executable-code components for execution by the processor 112. For example, an operating system can be stored in the memory 114 for execution by the processor 112. Where any component discussed herein is implemented in the form of software, any one of a number of programming languages can be employed such as, for example, C, C++, C #, Objective C, JAVA®, JAVASCRIPT®, Perl, PHP, VISUAL BASIC®, PYTHON®, RUBY, FLASH®, or other programming languages.

As discussed above, the memory 114 can store software for execution by the processor 112. In this respect, the terms “executable” or “for execution” refer to software forms that can ultimately be run or executed by the processor 112, whether in source, object, machine, or other form. Examples of executable programs include, for instance, a compiled program that can be translated into a machine code format and loaded into a random access portion of the memory 114 and executed by the processor 112, source code that can be expressed in an object code format and loaded into a random access portion of the memory 114 and executed by the processor 112, source code that can be interpreted by another executable program to generate instructions in a random access portion of the memory 114 and executed by the processor 112, or other executable programs or code.

The local interface 116 can be embodied as a data bus with an accompanying address/control bus or other addressing, control, and/or command lines. In part, the local interface 116 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 118 can include data for the computing device 102 such as, for instance, one or more unique identifiers for the computing device 102, digital certificates, encryption keys, session keys and session parameters for communications, and other data for reference and processing. The data store 118 can also store computer-readable instructions for execution by the computing device 102 via the processor 112, including instructions for the extended SCQC module 120, the quantum simulator module 122, the signal generator control module 124, and the communications stack 126. In some cases, the data store 118 can also store data indicative of the quantum related aspects (e.g., quantum dynamics, features, or properties) associated with various quantum computing devices or quantum operations to be performed, data indicative of one or more corrective control signals or corrective control fields that have been previously defined as described herein, and/or data indicative of empirical or simulated test results obtained from implementing or simulating such corrective control signal(s) or field(s).

The extended SCQC module 120 can be embodied as one or more software applications or services executing on the computing device 102. The extended SCQC module 120 can be executed by the processor 112 to design a quantum gate that is insensitive to different noise types as described herein. For instance, to design such a quantum gate, the extended SCQC module 120 can be configured to derive the above-described noise cancellation conditions that are to be satisfied to define a corrective control signal, construct a space curve that satisfies the noise cancellation conditions in a multidimensional space, and define or configure the corrective control signal by extracting (i.e., translating, calculating) its properties (e.g., parameters, control fields) from the geometric characteristics of the space curve. When implemented to drive a quantum operation, such a corrective control signal designed and configured by the extended SCQC module 120 as described below, can yield a dynamically corrected quantum gate that is insensitive to at least the different noise types described above.

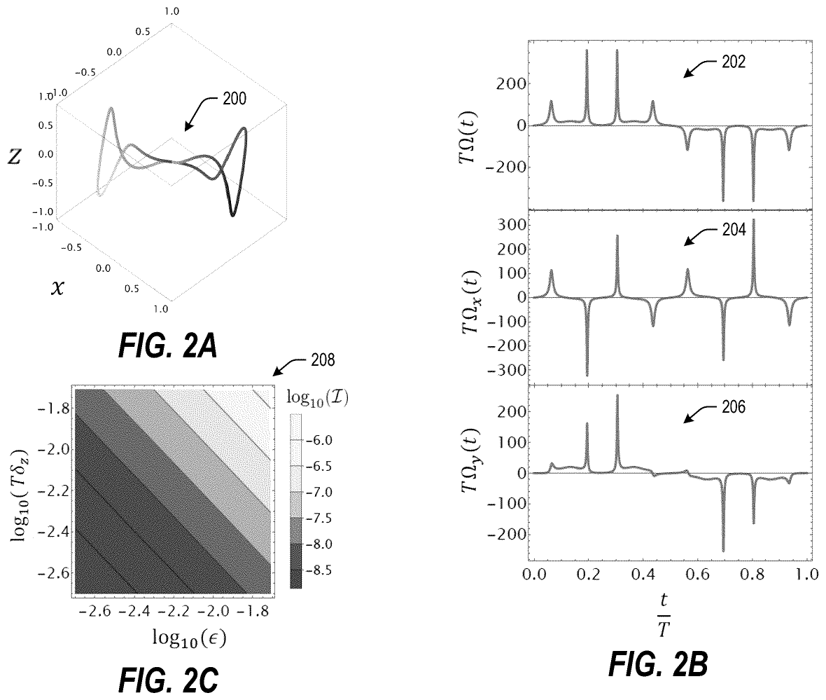

To design a quantum gate that is insensitive to different noise types in one example, the extended SCQC module 120 can first define the above-described noise cancellation conditions by implementing the methodology described herein with reference to Equations (1) to (14). In addition, as described below with reference to FIGS. 2A, 2B, 2C, 3A, 3B, 3C, 4A, 4B, 4C, and 4D, the extended SCQC module 120 can then construct a space curve that satisfies such conditions and define a corrective control signal based on the space curve by implementing the methodology described herein with reference to Equations (18), (19), and (23) to (35).

In one particular example, the extended SCQC module 120 can derive the above-described noise cancellation conditions for a general single-qubit Hamiltonian simultaneously subject to two types of noise, one additive, the other multiplicative. In this example, the extended SCQC module 120 can derive noise cancellation conditions to address quasistatic noise, which is pervasive in solid state qubits, where control time scales are fast compared to noise fluctuations. For instance, the extended SCQC module 120 can derive noise cancellation conditions on space curves that guarantee the simultaneous cancellation of both types of quasistatic noise (i.e., one additive, the other multiplicative). In this example, the extended SCQC module 120 can use a three-field control Hamiltonian of the form:

$${H}_{0} ( t ) = \frac{Ω ( t )}{2} ( cos Φ ( t ) {σ}_{x} + sin Φ ( t ) {σ}_{y} ) + \frac{Δ ( t )}{2} {σ}_{z} , \qquad ( 1 )$$

where Ω(t), φ(t), Δ(t) denote the driving, phase, and detuning fields, respectively, and σₓ, σ_{y}, σ_{z} are Pauli matrices. The extended SCQC module 120 can describe multiplicative errors in Ω(t) and additive errors in Δ(t) as:

$$Ω ( t ) \to ( 1 + ϵ ) Ω ( t ) , \qquad ( 2 )$$

$$Δ ( t ) \to Δ ( t ) + {δ}_{z} , \qquad ( 3 )$$

Where ϵ and δ_{z} are unknown, stochastic noise parameters that are assumed to be small and constant during the evolution. This model captures the common situation in which noise causes a slow, random rescaling of the driving field, as occurs for instance in exchange pulses in quantum dot spin qubits subject to charge noise. Additive fluctuations in Δ(t) are a widely used model of dephasing noise in qubit energy levels, where the dephasing time

$${T}_{2}^{*}$$

is set by the width of the distribution from which δ_{z} is sampled.

In this example, to quantify the deviation away from the ideal evolution caused by ϵ and δ_{z}, the extended SCQC module 120 can switch to the interaction picture defined by U₀(t), the evolution operator generated by H₀(t). The Magnus expansion of the interaction picture evolution operator is then controlled by the small parameters ϵ and δ₂. At first order the extended SCQC module 120 can obtain:

$${U}_{I} ( t ) \approx {e}^{- i {\prod }_{1} ( t )} , \qquad ( 4 )$$

$$with$$

$${\prod }_{1} ( t ) = {\int }_{0}^{t} {dt}^{′} {H}_{I} ( {t}^{′} ) = \frac{{δ}_{z}}{2} {\int }_{0}^{t} {dt}^{′} {U}_{0}^{†} ( {t}^{′} ) {σ}_{z} {U}_{0} ( {t}^{′} ) + \frac{ϵ}{2} {\int }_{0}^{t} {dt}^{′} {U}_{0}^{†} ( {t}^{′} ) Ω ( {t}^{′} ) ( cos Φ ( {t}^{′} ) {σ}_{x} + sin Φ ( {t}^{′} ) {σ}_{y} ) {U}_{0} ( {t}^{′} ) . \qquad ( 5 )$$

The extended SCQC module 120 can interpret the term proportional to δ₂ as a curve in three-dimensional (3D) Euclidean space that is referred to herein as the “space curve” or “error curve” \vec{r}(t):

$$\vec{r} ( t ) \cdot \vec{σ} ≡ {\int }_{0}^{t} {dt}^{′} {U}_{0}^{†} ( {t}^{′} ) {σ}_{z} {U}_{0} ( {t}^{′} ) \qquad ( 6 )$$

By construction, it then follows that cancelling transverse dephasing noise to first order in δ₂ corresponds to ensuring that \vec{r}(t) is a closed curve. To examine these 3D space curves, the extended SCQC module 120 can define an orthonormal frame called the Frenet-Serret frame, consisting of the tangent vector \vec{T}≡\vec{\dot{r}}, the normal vector \vec{N}=\vec{\dot{T}}/∥\vec{\dot{T}}∥, and the binormal vector \vec{B} ≡\vec{T}×\vec{N}. These vectors then satisfy the Frenet-Serret equations:

$$\dot{\vec{T}} = κ \vec{N} , \qquad ( 7 )$$

$$\dot{\vec{N}} = - κ \vec{T} + τ \vec{B} ,$$

$$\dot{\vec{B}} = - τ \vec{N} .$$

The functions κ and τ are the curvature and torsion of the curve, and via the Frenet-Serret equations, they can be used by the extended SCQC module 120 to uniquely determine the curve up to rigid rotations, in an interval where κ≠0. Once the extended SCQC module 120 identifies a closed space curve, it can determine the corresponding control fields Ω, Φ, and Δ from the curvature κ and torsion τ of the space curve:

$$κ = Ω , \qquad ( 8 )$$

$$τ = \dot{Φ} - Δ . \qquad ( 9 )$$

The extended SCQC module 120 can then determine that any closed space curve yields control fields that generate a quantum evolution that is insensitive to quasistatic transverse dephasing errors. The extended SCQC module 120 can also determine that Φ and Δ are not uniquely determined by the geometry of the space curve.

The extended SCQC module 120 can also write the second term in Equation (5) in terms of the space curve. From the definition of the space curve in Equation (6), the extended SCQC module 120 can determine that:

$$\begin{matrix}\dot{\vec{T}} ( t ) = \frac{d}{dt} ( {U}_{0}^{†} {σ}_{z} {U}_{0} ) \\ = {iU}_{0}^{†} [ {H}_{0} , {σ}_{z} ] {U}_{0} \\ = - 2 i ( {U}_{0}^{†} {σ}_{z} {U}_{0} ) {U}_{0}^{†} ( \begin{matrix}0 & \frac{Ω ( t )}{2} {e}^{- i Φ ( t )} \\ \frac{Ω ( t )}{2} {e}^{i Φ ( t )} & 0\end{matrix} ) {U}_{0} \\ = - 2 i ( \vec{T} ( t ) \cdot \vec{σ} ) {U}_{0}^{†} ( \begin{matrix}0 & \frac{Ω ( t )}{2} {e}^{- i Φ ( t )} \\ \frac{Ω ( t )}{2} {e}^{i Φ ( t )} & 0\end{matrix} ) {U}_{0} ,\end{matrix} \qquad ( 10 )$$

which implies that

$$Ω ( t ) {U}_{0}^{†} ( t ) ( cos Φ ( t ) {σ}_{x} + sin Φ ( t ) {σ}_{y} ) {U}_{0} ( t ) = i ( \vec{T} ( t ) \cdot \vec{σ} ) ( \dot{\vec{T}} ( t ) \cdot \vec{σ} ) = - ( \vec{T} ( t ) \times \dot{\vec{T}} ( t ) ) \cdot \vec{σ} . \qquad ( 11 )$$

Thus, the extended SCQC module 120 can determine that the leading-order errors from both types of noise can be expressed in terms of the tangent curve \vec{T}(t), where the extended SCQC module 120 can thereafter write Equation (5) as:

$${\prod }_{1} ( t ) = \vec{\frac{σ}{2}} \cdot {\int }_{0}^{t} {dt}^{′} ( - ϵ \vec{T} \times \dot{\vec{T}} + {δ}_{z} \vec{T} ) . \qquad ( 12 )$$

Accordingly, the extended SCQC module 120 can then determine that a doubly robust qubit evolution (U_{I}(T)≈1) requires that the following two conditions (i.e., noise cancellation conditions) be simultaneously satisfied:

$${\int }_{0}^{T} dt \vec{T} = 0 \qquad ( 13 )$$

$${\int }_{0}^{T} dt ( \vec{T} \times \dot{\vec{T}} ) = 0 \qquad ( 14 )$$

The second condition is proportional to the area swept out by the projection of the tangent vector onto each plane. Therefore, to cancel both types of error to first order, the extended SCQC module 120 can find a closed space curve \vec{r} whose tangent vector \vec{T} sweeps out zero area when projected onto any plane.

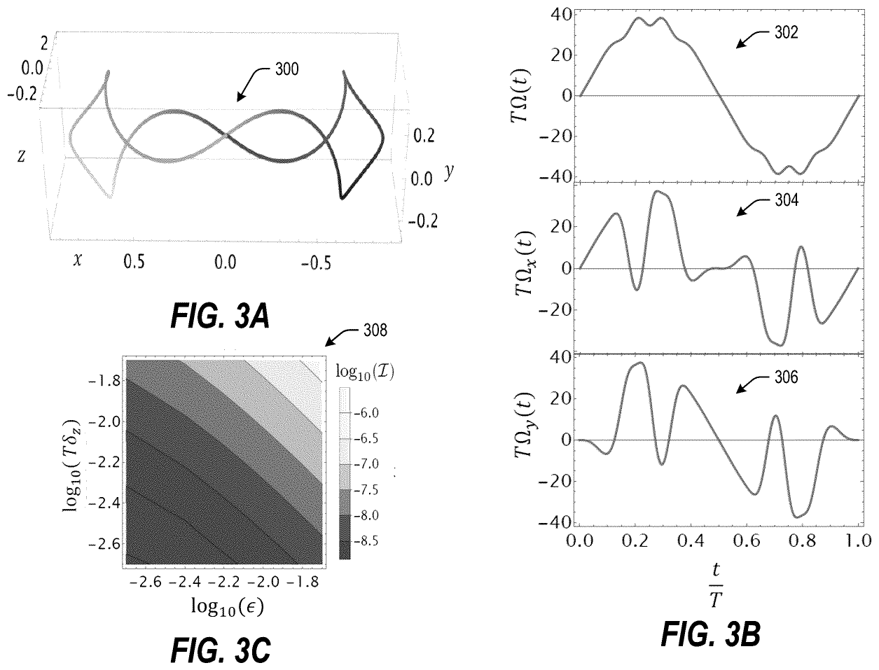

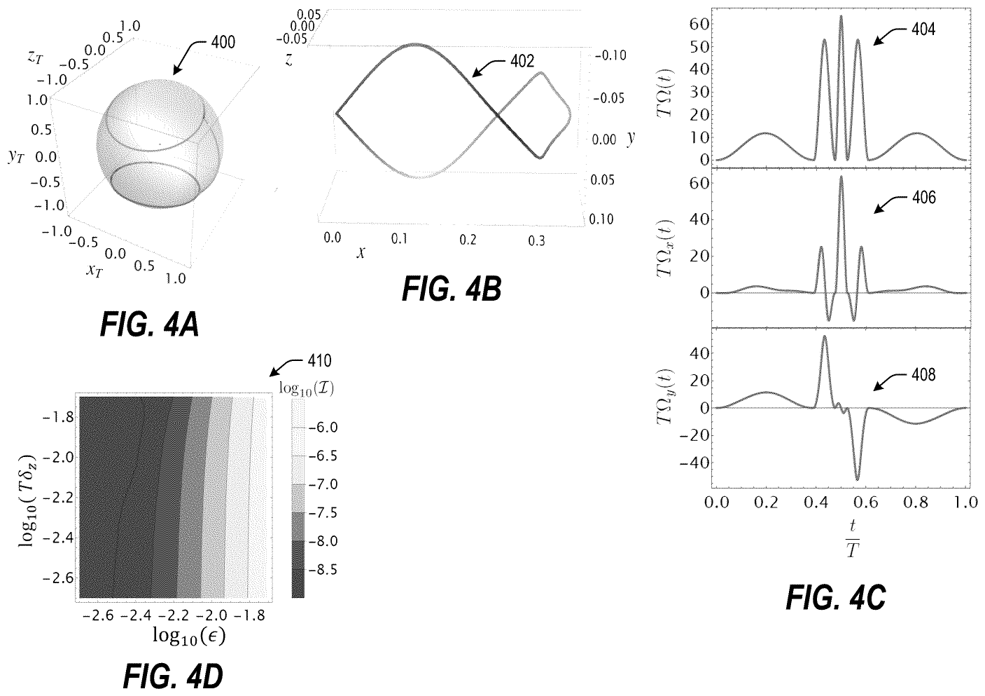

Once the extended SCQC module 120 has derived the noise cancellation conditions defined by Equations (13) and (14) as described above, the extended SCQC module 120 can construct a space curve that satisfies such conditions in a multidimensional (e.g., Euclidean) space. In one example, the extended SCQC module 120 can construct the space curve 200 described below with reference to FIG. 2A. In another example, the extended SCQC module 120 can construct the space curve 300 described below with reference to FIG. 3A. In another example, the extended SCQC module 120 can construct the space curve 402 described below with reference to FIGS. 4A and 4B. As described below with reference to FIGS. 2A, 3A, 4A, and 4B, each of the space curves 200, 300, 402 satisfies the noise cancellation conditions defined by Equations (13) and (14).

After constructing a space curve that satisfies the noise cancellation conditions defined by Equations (13) and (14), the extended SCQC module 120 can define a corrective control signal based on such a space curve. For example, as a space curve is representative of a control signal under the SCQC formalism, the extended SCQC module 120 can translate geometric characteristics (e.g., curvature and torsion characteristics) of the space curve into properties (e.g., parameters, control fields) of the control signal using Equations (8) and (9), among others described herein. As such, when the extended SCQC module 120 is able to construct a space curve that satisfies both noise cancellation conditions defined by Equations (13) and (14), the extended SCQC module 120 can use Equations (8) and (9), among others, to translate the curvature and torsion characteristics, respectively, of such a space curve into properties (e.g., parameters, control fields) of a corrective control signal. Such a corrective control signal can thereafter be implemented to drive a quantum operation while simultaneously cancelling transverse dephasing noise and control field noise.

In some examples, to define or configure a corrective control signal described herein, the extended SCQC module 120 can translate geometric characteristics (e.g., curvature and torsion characteristics) of a space curve that satisfies the noise cancellation conditions noted above into a driving field Ω(t), a phase field Φ(t), and a detuning field Δ(t) (collectively, “control fields”). In some cases, these control fields are indicative of or represent the properties or parameters that define a control signal such as a corrective control signal described herein. In one example, the extended SCQC module 120 can translate geometric characteristics of the space curve 200 described below with reference to FIG. 2A to extract control fields 202, 204, 206. In another example, the extended SCQC module 120 can translate geometric characteristics of the space curve 300 described below with reference to FIG. 3A to extract control fields 302, 304, 306. In another example, the extended SCQC module 120 can translate geometric characteristics of the space curve 402 described below with reference to FIGS. 4A and 4B to extract control fields 404, 406, 408.

The quantum simulator module 122 can be embodied as one or more software applications or services executing on the computing device 102. The quantum simulator module 122 can be executed by the processor 112 to simulate or cause an external device to simulate a quantum operation using a corrective control signal that can be defined or configured by the extended SCQC module 120 as described herein. Based on such simulation, the quantum simulator module 122 can generate or obtain performance data such as, for instance, gate infidelity data indicative of how well or how poorly the corrective control signal suppressed both transverse dephasing noise and control field noise associated with the simulated operation.

In one example, the quantum simulator module 122 can be configured to simulate a quantum operation on the computing device 102 using a corrective control signal that can be defined or configured by the extended SCQC module 120 as described herein. In another example, the quantum simulator module 122 can be configured to provide (e.g., via the networks 110) data indicative of the properties (e.g., parameters, control fields) of such a corrective control signal to a remote quantum simulator device. In this example, such a remote quantum simulator device can then use such data to simulate the quantum operation. For instance, in some cases, one of the remote computing devices 104 can be embodied or implemented as a special-purpose device such as a quantum simulator that can use the corrective control signal data provided by the quantum simulator module 122 to simulate a quantum effect or operation in a quantum system.

The signal generator control module 124 can be embodied as one or more software applications or services executing on the computing device 102. The signal generator control module 124 can be executed by the processor 112 to control or otherwise cause the signal generator 108 to generate and transmit various signals to the quantum computing device 106. For example, the signal generator control module 124 can cause the signal generator 108 to generate and transmit microwave and low-frequency electrical signals (e.g., pulses) to the quantum computing device 106. In some examples, the signal generator control module 124 can cause the signal generator 108 to generate and transmit, for instance, a resonant microwave pulse to drive a quantum operation performed by the quantum computing device 106. In other examples, the signal generator control module 124 can cause the signal generator 108 to generate and transmit a probing pulse to retrieve data indicative of the results observed from performing such an operation.

In one example, the signal generator control module 124 can cause the signal generator 108 to generate and transmit to the quantum computing device 106 a corrective control signal that can be defined or configured by the extended SCQC module 120 as described herein. In this example, the quantum computing device 106 can then perform a quantum operation using such a corrective control signal. Once the quantum computing device 106 performs the quantum operation using the corrective control signal, the signal generator control module 124 can then cause the signal generator 108 to generate and transmit a probing signal (e.g., pulse) to the quantum computing device 106 to retrieve data indicative of the results observed from the operation. Based on such results data, the computing device 102 can generate performance data such as, for instance, gate infidelity data indicative of how well or how poorly the corrective control signal suppressed both transverse dephasing noise and control field noise associated with the operation.

The communications stack 126 can include software and hardware layers to implement data communications such as, for instance, Bluetooth®, Bluetooth® Low Energy (BLE), WiFi®, cellular data communications interfaces, or a combination thereof. Thus, the communications stack 126 can be relied upon by the computing device 102 to establish cellular, Bluetooth®, WiFi®, and other communications channels with the networks 110 and with at least one of the remote computing devices 104 or the quantum computing device 106.

The communications stack 126 can include the software and hardware to implement Bluetooth®, BLE, and related networking interfaces, which provide for a variety of different network configurations and flexible networking protocols for short-range, low-power wireless communications. The communications stack 126 can also include the software and hardware to implement WiFi® communication, and cellular communication, which also offers a variety of different network configurations and flexible networking protocols for mid-range, long-range, wireless, and cellular communications. The communications stack 126 can also incorporate the software and hardware to implement other communications interfaces, such as X10®, ZigBee®, Z-Wave®, and others.

The communications stack 126 can be configured to communicate various data or information amongst the computing device 102, the remote computing devices 104, and the quantum computing device 106. Examples of such data or information can include, but is not limited to, at least one of data indicative of the quantum related aspects (e.g., quantum dynamics, features, or properties) associated with various quantum computing devices or quantum operations to be performed, data indicative of one or more corrective control signals or corrective control fields that have been defined or configured by the extended SCQC module 120 as described herein, data indicative of empirical or simulated test results obtained from implementing or simulating such corrective control signal(s) or field(s), or other data or information.

In some cases, the computing device 102 can implement the extended SCQC framework described herein as a service. For instance, in some cases, one or more of the remote computing devices 104 can send a request (e.g., via the networks 110) to the computing device 102 requesting the computing device 102 to design a corrective control signal described herein. For example, in some cases, one of the remote computing devices 104 can request that the computing device 102 design a corrective control signal that will be used to perform a certain quantum operation on a certain quantum computing device (e.g., the quantum computing device 106 or another quantum computing device).

In some cases, when submitting such a request, the remote computing device 104 can provide the computing device 102 with information about the quantum related aspects (e.g., quantum dynamics, features, or properties) associated with the quantum computing device and/or the quantum operation to be performed. As described herein, such quantum related aspects can create or contribute to certain noise types during a quantum operation such as, for instance, transverse dephasing noise and control field noise. In these cases, the computing device 102 (e.g., via the extended SCQC module 120) can use the quantum related aspects information provided by the remote computing device 104 to design a corrective control signal as described herein that can cancel transverse dephasing noise and control field noise when used to drive the quantum operation specified by the remote computing device 104.

FIG. 2A illustrates a diagram of an example space curve 200 according to at least one embodiment of the present disclosure. The space curve 200 is an example of a space curve that satisfies both noise cancellation conditions of Equations (13) and (14). In several examples, the computing device 102 can implement the extended SCQC module 120 to construct the space curve 200.

In some examples, the extended SCQC module 120 can construct the space curve 200 by using one or more quantum and multidimensional graphic design-based applications that allow for the generation, rendering, and manipulation of the space curve 200 in a 3D Euclidean space as described herein in accordance with several embodiments. In some cases, such generation, rendering, and manipulation of the space curve 200 can be facilitated by way of a user interface of such one or more applications such as, for instance, at least one of a graphical user interface (GUI), an application programming interface (API), or another user interface. In some cases, the extended SCQC module 120 can cause such generation, rendering, and manipulation of the space curve 200 to be rendered on a display device such as, for instance, at least one of a monitor, a screen, or another display device that can be included with or coupled to, or both included with and coupled to the computing device 102. In one example, the extended SCQC module 120 can construct the space curve 200 using one or more programming languages that include, but are not limited to, C, C++, C #, Objective C, Java®, JavaScript®, Perl, PHP, Visual Basic®, Python®, Ruby, Flash®, and Mathematica.

To construct the space curve 200 in one example, the extended SCQC module 120 can implement the methodology described herein with reference to Equations (18) and (19). In this example, the extended SCQC module 120 can implement a method that utilizes an ansatz consisting of even and odd parity space curve components containing trigonometric functions with frequencies fixed such that both robustness conditions are satisfied. In this and other examples, the space curve 200 can be referred to as a “parity curve.”

In one particular example, the extended SCQC module 120 can construct the space curve 200 by implementing an approach that utilizes the parity and periodicity of trigonometric functions. This class of curves can be written by the extended SCQC module 120 in the form:

$$\vec{r} ( λ ) = {f}_{x} ( {ω}_{x} λ ) \hat{x} + {f}_{y} ( {ω}_{y} λ ) \hat{y} + {f}_{z} ( {ω}_{z} λ ) \hat{z} , \qquad ( 18 )$$

where each function ƒᵢ(ωᵢλ) is periodic with period 2π/ωᵢ and either even or odd in λ. Parameterizations of this sort make it straightforward for the extended SCQC module 120 to impose symmetries in the space curve 200, and this in turn can make it easier for the extended SCQC module 120 to satisfy the noise cancellation conditions of Equations (13) and (14). In particular, curves whose components are all odd or all even functions satisfy these conditions. These “parity curves” are related to the trigonometric curves considered in certain literature on the differential geometry of curves. The periodicity of such functions guarantees the curve is closed, provided the extended SCQC module 120 chooses all the ratios of the frequencies to be rational numbers so that a least common multiple always exists. The parity property of the trigonometric functions ensures the curves have vanishing projected areas for both the space and tangent curves. For instance, if the extended SCQC module 120 starts with a curve whose components are of the even type, then \vec{\dot{r}} will contain odd functions, and \vec{\dot{r}} will contain even functions. Therefore, the integral of the cross product, Equation (14), will only contain odd functions, and thus, will vanish over the period of the curve.

The following is an example of a parity curve corresponding to the space curve 200 illustrated in FIG. 2A, where the extended SCQC module 120 chooses each component to be odd:

$$\vec{r} ( λ ) = sin ( λ / 2 ) \hat{x} + sin ( λ ) {cos}^{2} ( λ ) \hat{y} + sin ( λ ) \hat{z} . \qquad ( 19 )$$

Here, λ∈[0, 4π]. Before the extended SCQC module 120 can extract a pulse from this curve (i.e., the space curve 200), the extended SCQC module 120 can switch to the arclength parameterization t defined by

$${‖ \frac{d}{dt} \vec{r} ( λ ( t ) ) ‖}^{2} = 1$$

and such that t∈[0, T], where λ(T)=4π. From this, the extended SCQC module 120 can then determine that \vec{r}(T)=\vec{r}(λ(T))=0, and because of the built-in parity symmetry, the extended SCQC module 120 can also determine that the corresponding tangent curve \vec{T}(t)=\vec{\dot{r}}(t) satisfies Equation (14), indicating that both types of noise are cancelled. The extended SCQC module 120 can further determine that this curve (i.e., the space curve 200) also has vanishing projected areas,

$${\int }_{0}^{T} dt \vec{r} ( t ) \times \vec{T} ( t ) = 0 ,$$

so transverse dephasing noise is actually cancelled up to second order in this example.

FIG. 2B illustrates a diagram of example control fields 202, 204, 206 according to at least one embodiment of the present disclosure. The control fields 202, 204, 206 are examples of control fields that can be extracted from a space curve that satisfies both noise cancellation conditions of Equations (13) and (14). In the example depicted in FIG. 2B, the control fields 202, 204, 206 have been extracted from the space curve 200. In this example, Ωₓ=Ωcos Φ, Ω_{y}=Ω sin Φ, Δ=0, and T is the gate time. In several examples, the computing device 102 can implement the extended SCQC module 120 to extract the control fields 202, 204, 206 from the space curve 200.

To extract the control fields 202, 204, 206 from the space curve 200 in one example, the extended SCQC module 120 can implement the methodology described herein with reference to Equations (8), (9), (18), and (19). In this example, the extended SCQC module 120 can use Equation (9) to obtain the control fields 202, 204, 206 from the curvature and torsion of \vec{r}(t) of the space curve 200. In the examples depicted in FIGS. 2A and 2B, the space curve 200 and the control fields 202, 204, 206 can produce identity gates when implemented.

FIG. 2C illustrates a diagram of example gate infidelities 208 according to at least one embodiment of the present disclosure. The gate infidelities 208 are examples of gate infidelities I that can be obtained by implementing (e.g., via simulation or real-world experimentation) a corrective control signal described herein that can be extracted from a space curve that satisfies both noise cancellation conditions of Equations (13) and (14). In the example depicted in FIG. 2C, the gate infidelities 208 have been obtained by implementing the control fields 202, 204, 206 extracted from the space curve 200. In one example, the computing device 102 can implement the quantum simulator module 122 as described above with reference to FIG. 1 to obtain the gate infidelities 208 by simulating a quantum operation using the control fields 202, 204, 206. In another example, the computing device 102 can obtain the gate infidelities 208 by employing the quantum computing device 106 (e.g., via the signal generator control module 124 and the signal generator 108) to perform a real-world quantum operation using the control fields 202, 204, 206.

The gate infidelities 208 are depicted in FIG. 2C as a function of the strengths of both the transverse dephasing noise (δ_{z}) and the control field noise (ϵ). In this example, the infidelity scales better than the expected ϵ², (Tδ_{z})² scaling. The improved scaling in Tδ_{z} can be understood from the fact that the projected areas of the space curve 200 all vanish, as noted above. The ϵ scaling suggests that the ϵ² term in the Magnus expansion also vanishes for this example; this in turn may be a consequence of the parity symmetry. Further investigation of the higher-order terms of the Magnus expansion would be needed to confirm this. Although the use of parity curves makes it easy for the extended SCQC module 120 to satisfy both noise-cancellation constraints at the same time, the control fields 202, 204, 206 in this example as shown in FIG. 2B may be difficult to implement in practice due to their sharp (although non-singular) features. In the examples described below and illustrated in FIGS. 3A, 3B, 3C, 4A, 4B, 4C, and 4D, two additional methods are provided for constructing space curves that satisfy both noise cancellation conditions of Equations (13) and (14) while also yielding more experimentally friendly pulse shapes.

FIG. 3A illustrates a diagram of an example space curve 300 according to at least one embodiment of the present disclosure. The space curve 300 is an example of a space curve that satisfies both noise cancellation conditions of Equations (13) and (14). In several examples, the computing device 102 can implement the extended SCQC module 120 to construct the space curve 300.

In some examples, the extended SCQC module 120 can construct the space curve 300 by using one or more quantum and multidimensional graphic design-based applications that allow for the generation, rendering, and manipulation of the space curve 300 in a 3D Euclidean space as described herein in accordance with several embodiments. In some cases, such generation, rendering, and manipulation of the space curve 300 can be facilitated by way of a user interface of such one or more applications such as, for instance, at least one of a GUI, an API, or another user interface. In some cases, the extended SCQC module 120 can cause such generation, rendering, and manipulation of the space curve 300 to be rendered on a display device such as, for instance, at least one of a monitor, a screen, or another display device that can be included with or coupled to, or both included with and coupled to the computing device 102. In one example, the extended SCQC module 120 can construct the space curve 300 using one or more programming languages that include, but are not limited to, C, C++, C #, Objective C, Java®, JavaScript®, Perl, PHP, Visual Basic®, Python®, Ruby, Flash®, and Mathematica.

To construct the space curve 300 in one example, the extended SCQC module 120 can implement the methodology described herein with reference to Equations (23) to (32). In this example, the extended SCQC module 120 can implement a method that accomplishes the cancellation of errors by utilizing an ansatz for the tangent curve for which Equation (14) is enforced by symmetry. By choosing parameters equal to Bessel function roots, the extended SCQC module 120 can guarantee closure of a space curve so that Equation (13) is also satisfied, yielding “Bessel curves.” In this and other examples, the space curve 300 can be referred to as a “Bessel curve.”

In one particular example, the extended SCQC module 120 can construct the space curve 300 by first defining the following ansatz for the normalized tangent curve:

$$\vec{T} ( θ ( t ) ) = ( cos ( q θ ) sin θ , sin ( q θ ) sin θ , cos θ ) , \qquad ( 23 )$$

where q is a proportionality constant between the azimuthal and polar angles. This formulation provides a space curve that is already expressed in its own arclength parameterization, and which is solely controlled by a function θ(t). This ansatz makes the pulse error constraint particularly simple:

$${\int }_{0}^{T} dt ( \vec{T} \times \dot{\vec{T}} ) = {\int }_{θ ( 0 )}^{θ ( T )} d θ ( \vec{T} \times \frac{\partial \vec{T}}{\partial θ} ) = 0 , \qquad ( 24 )$$

where examination of the third component by the extended SCQC module 120 forces the requirement of

$$θ ( 0 ) = θ ( T ) . \qquad ( 25 )$$

This one boundary constraint is equivalent to the vanishing area condition, Equation (14), along all 3 projections. For the space curve 300 to be closed, the extended SCQC module 120 also needs 3 real integrals to vanish. The extended SCQC module 120 can obtain these integrals by plugging Equation (23) into Equation (13). However, to simplify the process of finding suitable functions θ(t), the extended SCQC module 120 can upgrade these to 3 complex integral constraints:

$${\int }_{0}^{T} {e}^{i θ ( t )} dt = 0 , \qquad ( 26 )$$

$${\int }_{0}^{T} {e}^{i θ ( t ) ( 1 \pm q )} dt = 0 , \qquad ( 27 )$$

where the extended SCQC module 120 can understand Equation (27) as two separate constraints, one for each choice of the sign in front of q. Although Equations (26) and (27) are generally stronger constraints than Equation (13), these complex constraints have the advantage that they can be solved approximately by the extended SCQC module 120 using Bessel functions, as explained in more detail below. If the extended SCQC module 120 chooses q=0, then Equation (27) becomes redundant, and the one independent integral constraint that remains, Equation (26), coincides with the closed-curve constraint for plane curves. This is to be expected, since setting q=0 in Equation (23) restricts the tangent curve, and hence the space curve 300, to the XZ plane. In this case, the extended SCQC module 120 can interpret θ(t) as the curvature of the plane curve, and Equation (13) is equivalent to Equation (26). The zero-area constraint on the tangent curve, Equation (14), remains equivalent to Equation (25).

For any other value of q≠0, Equation (27) imposes an independent constraint on the space curve 300. The extended SCQC module 120 can determine the magnitude of the curvature of the space curve 300 as being given by

$$\vert κ ( t ) \vert = \sqrt{{q}^{2} {sin}^{2} ( θ ( t ) ) + 1} \vert \dot{θ} ( t ) \vert . \qquad ( 28 )$$

Here, the extended SCQC module 120 can identify that if it imposes \dot{θ}(0)=0=\dot{θ} (T), the resulting pulse envelope Ω(t)=κ(t) will start and end at zero as should be the case for a smooth pulse. The extended SCQC module 120 can satisfy this condition and Equation (25) by the following ansatz:

$$θ ( t ) = {x}_{i} cos ( \frac{2 π}{T} t ) , \qquad ( 29 )$$

Where xᵢ is a real constant. The space curve 300 obtained from this choice of θ(t) is referred to herein as a “Bessel curve.” By inserting this ansatz into Equations (26) and (27) and comparing the results to the integral representation of the Bessel function of the first kind, the extended SCQC module 120 can determine that all the space curve constraints for the space curve 300 (i.e., the noise cancellation conditions of Equations (13) and (14)) are satisfied by choosing xᵢ and (1±q) xᵢ to be Bessel function zeros:

$${J}_{0} ( {x}_{i} ) = 0 , \qquad ( 30 )$$

$${J}_{0} ( ( 1 \pm q ) {x}_{i} ) = 0. \qquad ( 31 )$$

In the case of a plane curve (q=0), the resulting evolution generated by the sinusoidal Ω(t) is robust to pulse errors since Equation (25) holds. Additionally, the extended SCQC module 120 can determine that there exist particular pulse amplitudes xᵢ for which dephasing noise is also suppressed. For more general values of q≠0, the extended SCQC module 120 will have a 3D space curve and the extended SCQC module 120 can choose q so that both (1+q)xᵢ and (1−q)xᵢ are also Bessel function zeros. Instead of attempting to find values of q for which these quantities are both exact zeros, the extended SCQC module 120 can make them approximate zeros by finding a q that minimizes [(1−q)xᵢ−xᵢ_{₋₁}]²+[(1+q)xᵢ−xᵢ_{₊₁}]². For three consecutive exact Bessel zeros xᵢ_{₋₁}, xᵢ, xᵢ_{₊₁}, the extended SCQC module 120 can approximately minimize this function when

$$q = \frac{{x}_{{i}_{+ 1}} - {x}_{{i}_{- 1}}}{{2}_{{x}_{i}}} . \qquad ( 32 )$$

The parameters xᵢ and q together give the extended SCQC module 120 discrete control over the smoothness of the space curve 300 and, hence, the bandwidth of the resulting control field (i.e., the control fields 302, 304, 306 described below and illustrated in FIG. 3B). The space curve 300 depicted in FIG. 3A can be constructed by the extended SCQC module 120 in one example using Equations (23) and (29) with the choice xᵢ=5.5201, q=0.5660.

FIG. 3B illustrates a diagram of example control fields 302, 304, 306 according to at least one embodiment of the present disclosure. The control fields 302, 304, 306 are examples of control fields that can be extracted from a space curve that satisfies both noise cancellation conditions of Equations (13) and (14). In the example depicted in FIG. 3B, the control fields 302, 304, 306 have been extracted from the space curve 300. In this example, Ωₓ=Ωcos Φ, Ω_{y}=Ω sin Φ, Δ=0, and T is the gate time. In several examples, the computing device 102 can implement the extended SCQC module 120 to extract the control fields 302, 304, 306 from the space curve 300.

To extract the control fields 302, 304, 306 from the space curve 300 in one example, the extended SCQC module 120 can implement the methodology described herein with reference to Equations (8), (9), (23), and (29). In the examples depicted in FIGS. 3A and 3B, the space curve 300 and the control fields 302, 304, 306 can implement a doubly robust identity gate when implemented.

FIG. 3C illustrates a diagram of example gate infidelities 308 according to at least one embodiment of the present disclosure. The gate infidelities 308 are examples of gate infidelities/that can be obtained by implementing (e.g., via simulation or real-world experimentation) a corrective control signal described herein that can be extracted from a space curve that satisfies both noise cancellation conditions of Equations (13) and (14). In the example depicted in FIG. 3C, the gate infidelities 308 have been obtained by implementing the control fields 302, 304, 306 extracted from the space curve 300. In one example, the computing device 102 can implement the quantum simulator module 122 as described above with reference to FIG. 1 to obtain the gate infidelities 308 by simulating a quantum operation using the control fields 302, 304, 306. In another example, the computing device 102 can obtain the gate infidelities 308 by employing the quantum computing device 106 (e.g., via the signal generator control module 124 and the signal generator 108) to perform a real-world quantum operation using the control fields 302, 304, 306.

The gate infidelities 308 are depicted in FIG. 3C as a function of the strengths of both the transverse dephasing noise (δ_{z}) and the control field noise (ϵ). In the example depicted in FIG. 3C, the gate infidelities 308 provide confirmation of the insensitivity of the resulting Z gates to both transverse dephasing noise and multiplicative control field noise. Different Z rotations can be constructed if the extended SCQC module 120 adjusts the gauge choice for Φ and Δ as discussed above with reference to FIGS. 2A, 2B, and 2C. The robustness of the space curve 300 persists across all possible Z-rotations. Additionally, the space curve 300 also has vanishing projected areas, and therefore, second-order dephasing errors are also suppressed.

FIG. 4A illustrates a diagram of an example tangent curve 400 according to at least one embodiment of the present disclosure. FIG. 4B illustrates a diagram of an example space curve 402 according to at least one embodiment of the present disclosure. The tangent curve 400 is an example of a curve that satisfies the noise cancellation conditions of Equation (14) and the space curve 402 is an example of a curve that satisfies both the noise cancellation conditions of Equation (13) and (14). In several examples, the computing device 102 can implement the extended SCQC module 120 to construct the tangent curve 400 and the space curve 402.

In some examples, the extended SCQC module 120 can construct the tangent curve 400 and the space curve 402 by using one or more quantum and multidimensional graphic design-based applications that allow for the generation, rendering, and manipulation of such curves in a 3D Euclidean space as described herein in accordance with several embodiments. In some cases, such generation, rendering, and manipulation of the tangent curve 400 and the space curve 402 can be facilitated by way of a user interface of such one or more applications such as, for instance, at least one of a GUI, an API, or another user interface. In some cases, the extended SCQC module 120 can cause such generation, rendering, and manipulation of the tangent curve 400 and the space curve 402 to be rendered on a display device such as, for instance, at least one of a monitor, a screen, or another display device that can be included with or coupled to, or both included with and coupled to the computing device 102. In one example, the extended SCQC module 120 can construct the tangent curve 400 and the space curve 402 using one or more programming languages that include, but are not limited to, C, C++, C #, Objective C, Java®, JavaScript®, Perl, PHP, Visual Basic®, Python®, Ruby, Flash®, and Mathematica.

The tangent curve 400 shown in FIG. 4A is a “tilted circles” tangent curve for θ=π/2. The hue of the curve indicates the manner in which it is traced. Also depicted in FIG. 4A is the origin of the tangent curve 400 to show that the origin is contained in the convex hull of this curve. The space curve 402 is a closed space curve that can be generated by the extended SCQC module 120 from the tangent curve 400. The hue of the space curve 402 matches that of the tangent curve 400 and it shows the speed at which different sections of the tangent curve 400 are traversed.

To construct the tangent curve 400 and the space curve 402 in one example, the extended SCQC module 120 can implement the methodology described herein with reference to Equations (33) to (35). In this example, the extended SCQC module 120 can implement a method of constructing the tangent curve 400 on a sphere such that the tangent curve 400 traces out “tilted circles” that sweep zero area while also containing the origin in its convex hull. As such, in this and other examples, the tangent curve 400 can be referred to as a “tilted circles curve” or a “tilted circles tangent curve.”

In one particular example, the extended SCQC module 120 can construct the tangent curve 400 by first observing that the integral giving the area swept out by the tangent curve is independent of the parameterization of that curve:

$${\int }_{0}^{T} \vec{T} \times \dot{\vec{T}} dt = \int \vec{T} \times d \vec{T} . \qquad ( 33 )$$

Thus, the extended SCQC module 120 can start by drawing a tangent curve (i.e., the tangent curve 400) that sweeps out zero area, and then it can try to find a parameterization such that the space curve is closed (i.e., such that the space curve 402 is closed). The extended SCQC module 120 can let s be the arclength of \vec{T}, i.e., ∥d\vec{T}/ds∥=1.

Then after designing a tangent curve \vec{T}(s) that sweeps out zero area (i.e., after designing the tangent curve 400), the extended SCQC module 120 can find a parameterization s (t) that gives a closed space curve upon integrating \vec{T}(s(t))=\vec{T}(t), to yield the space curve 402.

The curvature k and torsion τ of \vec{r} are related to \vec{T}(t) as follows:

$$κ = ‖ \dot{\vec{T}} ‖ = \frac{ds}{dt} , \qquad ( 34 )$$

$$τ = - \vec{N} \cdot \dot{\vec{B}} = - \vec{N} \cdot \frac{d}{dt} ( \vec{T} \times \vec{N} ) = - \frac{1}{κ} \dot{\vec{T}} \cdot \frac{d}{dt} ( \vec{T} \times \frac{1}{κ} \dot{\vec{T}} ) = - \frac{1}{κ} \frac{d}{dt} \vec{T} \cdot \vec{T} \times κ {( \frac{1}{κ} \frac{d}{dt} )}^{2} \vec{T} = κ \vec{T} \cdot \frac{d \vec{T}}{ds} \times \frac{{d}^{2} \vec{T}}{{ds}^{2}} . \qquad ( 35 )$$

The vector triple product above is the geodesic curvature of the tangent curve k_{g},T, so the extended SCQC module 120 can write this relationship can as T/k=k_{g}, T.

Not every tangent curve can be reparameterized to give a closed space curve, however. As such, the extended SCQC module 120 can use a visual criterion to determine if a given T curve can yield a closed space curve:

Theorem 1, which recites, “A tangent curve \vec{T}(s) can generate a closed space curve if and only if the convex hull of \vec{T}(s) contains the origin.” The extended SCQC module 120 can use the general method of Theorem 1 to find a family of pulses yielding x-rotations X_{θ}, which when combined with virtual z-rotations and/or phase ramping can yield any single-qubit gate.

In the example depicted in FIG. 4C, the control fields 404, 406, 408 have be derived by the extended SCQC module 120 from tangent curves of “tilted circles” such as the tangent curve 400 and the space curve 402 illustrated in FIGS. 4A and 4B, respectively. As shown in FIGS. 4A and 4B, the curve goes from \vec{T}₀,=(cos (θ/2), 0, sin (θ/2))^{T} to \vec{T}_{f},=(cos (−θ/2), 0, sin (−θ=2))^{T} along a great circle arc. However, it goes around two smaller circles before and after, to cancel the area swept out by the great circle arc. The upper and lower circles are normal to the vectors \hat{n}₀=(0, −sin α, cos α)^{T} and \hat{η}_{f}=(0, −sin α, −cos α)^{T}, respectively. The sign of the normal vectors is chosen by the extended SCQC module 120 so that the area contribution from the circle points along \hat{n}:

$${\vec{A}}_{circle} = π {r}_{circle}^{2} \hat{n} = π {sin}^{2} γ \hat{n} , \qquad ( 36 )$$

where γ is defined as the angle between \vec{T}₀ and \vec{n}₀ (and the angle between \vec{T}^{f} and \vec{n}_{f}):

$$cos γ = {\vec{T}}_{0} \cdot {\vec{n}}_{0} = {\vec{T}}_{f} \cdot {\hat{n}}_{f} = sin \frac{θ}{2} cos α . \qquad ( 37 )$$

The area contribution of the arc from \vec{T}₀ to \vec{T}_{f} is \vec{A}_{arc}=θ/2ŷ, and the total area swept out is

$$\vec{A} = \frac{θ}{2} \hat{y} + π {sin}^{2} γ ( {\vec{n}}_{0} + {\hat{n}}_{f} ) = ( \frac{θ}{2} - 2 π sin α ( 1 - {sin}^{2} ( \frac{θ}{2} ) {cos}^{2} α ) ) \hat{y} . \qquad ( 38 )$$

In order to cancel driving error, the extended SCQC module 120 can require \vec{A}=0, which gives an implicit equation defining α(θ): 2π sin α(1−sin² (θ/2) cos² α)=θ/2. The extended SCQC module 120 can also determine that the origin is contained in the convex hull of this curve depicted in FIGS. 4A and 4B, and so it can be reparameterized by the extended SCQC module 120 to give a closed space curve (i.e., the space curve 402). In the examples depicted in FIGS. 4A, 4B, 4C, and 4D, the extended SCQC module 120 validates the inclusion of the origin in the convex hull of the tangent curve 400 and the gate infidelities 410 of the resulting evolution is illustrated in FIG. 4D. The area of low infidelity depicted in FIG. 4D is the largest among all results obtained and illustrated in FIGS. 2C, 3C, and 4D, which emphasizes the fact that the degree of error cancellation affects the rate at which the quality of the gate degrades with increasing noise strength and not its absolute fidelity.

FIG. 4C illustrates a diagram of example control fields 404, 406, 408 according to at least one embodiment of the present disclosure. The control fields 404, 406, 408 are examples of control fields that can be extracted from a space curve that satisfies both noise cancellation conditions of Equations (13) and (14). In the example depicted in FIG. 4C, the control fields 404, 406, 408 have been extracted from the space curve 402. In several examples, the computing device 102 can implement the extended SCQC module 120 to extract the control fields 404, 406, 408 from the space curve 402.

To extract the control fields 404, 406, 408 from the space curve 402 in one example, the extended SCQC module 120 can implement the methodology described herein with reference to Equations (8), (9), and (33) to (38). In the example shown in FIG. 4C, the control fields 404, 406, 408 can produce a double robust

$$R ( \frac{π}{2} X )$$

gate when implemented. In this example, to achieve the desired z-rotation angle, the extended SCQC module 120 can choose a constant detuning field appropriately.

FIG. 4D illustrates a diagram of example gate infidelities 410 according to at least one embodiment of the present disclosure. The gate infidelities 410 are examples of gate infidelities/that can be obtained by implementing (e.g., via simulation or real-world experimentation) a corrective control signal described herein that can be extracted from a space curve that satisfies both noise cancellation conditions of Equations (13) and (14). In the example depicted in FIG. 4D, the gate infidelities 410 have been obtained by implementing the control fields 404, 406, 408 extracted from the space curve 402. In one example, the computing device 102 can implement the quantum simulator module 122 as described above with reference to FIG. 1 to obtain the gate infidelities 410 by simulating a quantum operation using the control fields 404, 406, 408. In another example, the computing device 102 can obtain the gate infidelities 410 by employing the quantum computing device 106 (e.g., via the signal generator control module 124 and the signal generator 108) to perform a real-world quantum operation using the control fields 404, 406, 408. FIG. 4D illustrates the gate infidelities 410 of the tilted curve-based

$$R ( \frac{π}{2} X )$$

gate versus transverse dephasing noise strength (δ_{z}) and multiplicative driving field noise strength (ϵ).

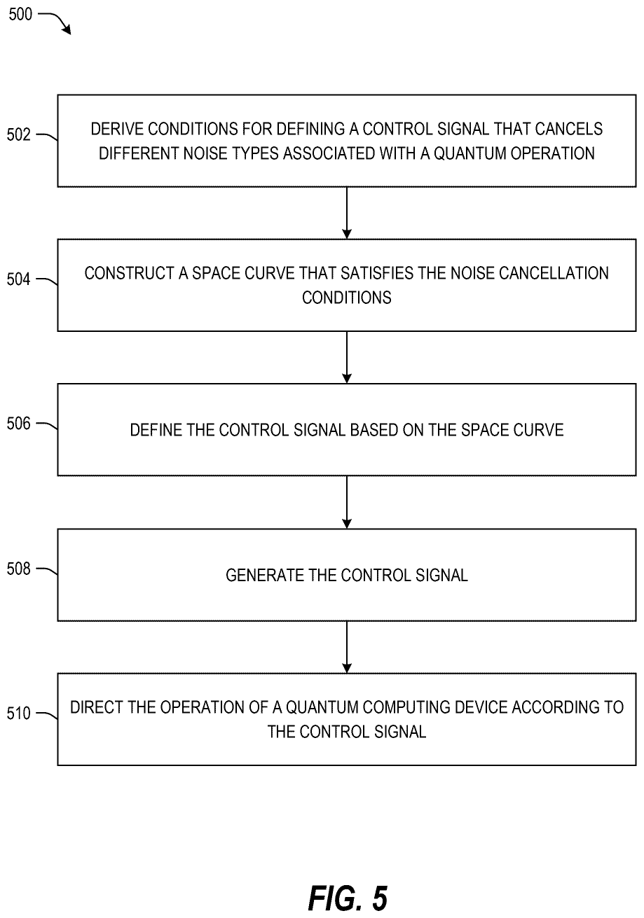

FIG. 5 illustrates a flow diagram of an example computer-implemented method 500 according to at least one embodiment of the present disclosure. The computer-implemented method 500 (“the method 500”) can be implemented to design a dynamically corrected quantum gate that is insensitive to different noise types associated with a quantum operation as described herein. In one example, the method 500 can be implemented by the computing device 102 in the context of the environment 100 using, for instance, the extended SCQC module 120.

At 502, the method 500 can include deriving conditions for defining a control signal that cancels different noise types associated with a quantum operation. For example, as described above with reference to FIG. 1, the computing device 102 can implement the extended SCQC module 120 to derive noise cancellation conditions that are to be satisfied to define a corrective control signal that cancels different noise types associated with performing a quantum operation when the corrective control signal is used to drive the quantum operation.

In one example, the computing device 102 can implement the extended SCQC module 120 to derive Equation (13) and (14) defined above. As described above with reference to FIG. 1, when satisfied, Equation (13) provides for cancellation of transverse dephasing noise and Equation (14) provides for cancellation of control field noise (or “pulse error noise”). When the noise cancellation conditions defined by Equations (13) and (14) are both satisfied, a control signal whose properties (e.g., parameters, control fields) are defined based on such conditions can simultaneously cancel transverse dephasing noise and control field noise.

At 504, the method 500 can include constructing a space curve that satisfies the noise cancellation conditions. For example, as described above with reference to FIG. 1, the computing device 102 can implement the extended SCQC module 120 to construct a space curve that satisfies the noise cancellation conditions of Equations (13) and (14) in a multidimensional Euclidean space. Once a space curve is constructed to satisfy the noise cancellation conditions defined by Equations (13) and (14), such a space curve is representative of a corrective control signal that can be implemented to drive a quantum operation while simultaneously cancelling both transverse dephasing noise and control field noise.

In one example, the computing device 102 can implement the extended SCQC module 120 to construct the space curve 200 as described above with reference to FIG. 2A. In another example, the computing device 102 can implement the extended SCQC module 120 to construct the space curve 300 as described above with reference to FIG. 3A. In another example, the computing device 102 can implement the extended SCQC module 120 to construct the space curve 402 as described above with reference to FIGS. 4A and 4B. As described above with reference to FIGS. 2A, 3A, 4A, and 4B, each of the space curves 200, 300, 402 satisfies the noise cancellation conditions defined by Equations (13) and (14).

At 506, the method 500 can include defining the control signal based on the space curve. For example, as described above with refence to FIG. 1, as a space curve is representative of a control signal under the SCQC formalism, the computing device 102 can implement the extended SCQC module 120 to translate geometric characteristics (e.g., curvature and torsion characteristics) of the space curve into properties (e.g., parameters, control fields) of the control signal. To achieve this, the extended SCQC module 120 can use Equations (8) and (9), among others described herein. When the computing device 102 (e.g., via the extended SCQC module 120) is able to construct a space curve that satisfies both noise cancellation conditions defined by Equations (13) and (14), the computing device 102 can implement the extended SCQC module 120 to translate the curvature and torsion characteristics of such a space curve into properties (e.g., parameters, control fields) of a corrective control signal described herein.

In one example, the computing device 102 can implement the extended SCQC module 120 to translate curvature and torsion characteristics of the space curve 200 into the control fields 202, 204, 206 as described above with reference to FIG. 2B. In another example, the computing device 102 can implement the extended SCQC module 120 to translate curvature and torsion characteristics of the space curve 300 into the control fields 302, 304, 306 as described above with reference to FIG. 3B. In another example, the computing device 102 can implement the extended SCQC module 120 to translate curvature and torsion characteristics of the space curve 402 into the control fields 404, 406, 408 as described above with reference to FIG. 4C. As described above with reference to FIGS. 2A, 3A, 4A, and 4B, each of the space curves 200, 300, 402 satisfies the noise cancellation conditions defined by Equations (13) and (14).

At 508, the method 500 can include generating the control signal. For example, as described above with refence to FIG. 1, the computing device 102 can implement the signal generator control module 124 to cause the signal generator 108 to generate a corrective control signal that can be defined or configured by the extended SCQC module 120 as described herein. To cause the signal generator 108 to generate the control signal at 508 of the method 500, in some cases the signal generator control module 124 can provide the signal generator 108 with data indicative of such a signal. In these cases, the signal generator 108 can then use such data to generate the control signal.

In one example, the control signal at 508 of the method 500 can be embodied as a corrective control signal that has been defined based on the space curve 200. In this example, the signal generator control module 124 can provide the signal generator 108 with data indicative of the properties of such a corrective control signal that have been extracted from the curvature and torsion characteristics of the space curve 200 as described above with reference to FIG. 2A. For instance, the signal generator control module 124 can provide the signal generator 108 with data indicative of the control fields 202, 204, 206 described above and illustrated in FIG. 2B. In this example, the signal generator 108 can then generate the corrective control signal corresponding to the space curve 200 based on such data provided by the signal generator control module 124.

In another example, the control signal at 508 of the method 500 can be embodied as a corrective control signal that has been defined based on the space curve 300. In this example, the signal generator control module 124 can provide the signal generator 108 with data indicative of the properties of such a corrective control signal that have been extracted from the curvature and torsion characteristics of the space curve 300 as described above with reference to FIG. 3A. For instance, the signal generator control module 124 can provide the signal generator 108 with data indicative of the control fields 302, 304, 306 described above and illustrated in FIG. 3B. In this example, the signal generator 108 can then generate the corrective control signal corresponding to the space curve 300 based on such data provided by the signal generator control module 124.

In another example, the control signal at 508 of the method 500 can be embodied as a corrective control signal that has been defined based on the space curve 402. In this example, the signal generator control module 124 can provide the signal generator 108 with data indicative of the properties of such a corrective control signal that have been extracted from the curvature and torsion characteristics of the space curve 402 as described above with reference to FIGS. 4A and 4B. For instance, the signal generator control module 124 can provide the signal generator 108 with data indicative of the control fields 404, 406, 408 described above and illustrated in FIG. 4C. In this example, the signal generator 108 can then generate the corrective control signal corresponding to the space curve 402 based on such data provided by the signal generator control module 124.

At 510, the method 500 can include directing the operation of a quantum computing device according to the control signal. For example, the computing device 102 can implement the signal generator control module 124 to effectively direct the operation of the quantum computing device 106 by causing the signal generator 108 to transmit the control signal generated at 508 to the quantum computing device 106. In this example, the quantum computing device 106 can then use the control signal generated at 508 to drive a quantum operation performed by the quantum computing device 106. In this example, the control signal generated at 508 can drive the quantum operation such that transverse dephasing noise and control field noise associated with the operation are simultaneously cancelled by the effects of the control signal.

Referring now to FIG. 1, an executable program can be stored in any portion or component of the memory 114. The memory 114 can be embodied as, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

The memory 114 can include both volatile and nonvolatile memory and data storage components. Volatile components are those that do not retain data values upon loss of power. Nonvolatile components are those that retain data upon a loss of power. Thus, the memory 114 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory devices.

As discussed above, the extended SCQC module 120, the quantum simulator module 122, the signal generator control module 124, and the communications stack 126 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 5, the flowchart or process diagram shown in FIG. 5 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 112. The machine code can be converted from the source code. Further, each block can represent, or be connected with, a circuit or a number of interconnected circuits to implement a certain logical function or process step.

Although the flowchart or process diagram shown in FIG. 5 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the extended SCQC module 120, the quantum simulator module 122, the signal generator control module 124, and the communications stack 126 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 5. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method of defining a control signal that cancels multiple noise types in a quantum computing device, the method comprising:
deriving, by a computing device, noise cancellation conditions that are to be satisfied to define a corrective control signal that cancels different noise types associated with performing a quantum operation when the corrective control signal is used to drive the quantum operation;
constructing, by the computing device, a space curve that satisfies the noise cancellation conditions in a multidimensional space, the space curve being representative of the corrective control signal; and
defining, by the computing device, the corrective control signal based on the space curve.

2. The method of claim 1, wherein the different noise types comprise a multiplicative noise type.

3. The method of claim 1, wherein the different noise types comprise transverse dephasing noise.

4. The method of claim 1, wherein the different noise types comprise control field noise.

5. The method of claim 1, wherein the noise cancellation conditions comprise a geometric condition that the space curve be a closed curve.

6. The method of claim 1, wherein the noise cancellation conditions comprise a geometric condition where a derivative of the space curve satisfies a zero-area condition.

7. The method of claim 1, wherein the noise cancellation conditions correspond to geometric conditions of the space curve, and wherein constructing the space curve comprises:
constructing, by the computing device, the space curve according to the geometric conditions in the multidimensional space.

8. The method of claim 1, wherein constructing the space curve comprises:
constructing, by the computing device, a tangent curve that satisfies one of the noise cancellation conditions; and
integrating, by the computing device, the tangent curve to obtain the space curve.

9. The method of claim 1, wherein defining the corrective control signal based on the space curve comprises:
translating, by the computing device, geometric characteristics of the space curve into properties of the corrective control signal.

10. The method of claim 1, wherein defining the corrective control signal based on the space curve comprises:
extracting, by the computing device, curvature characteristics and torsion characteristics from the space curve, the curvature characteristics and the torsion characteristics respectively corresponding to different properties of the corrective control signal.

11. The method of claim 1, further comprising:
implementing, by the computing device, the corrective control signal to perform the quantum operation, wherein the corrective control signal dynamically cancels the different noise types simultaneously during the quantum operation.

12. The method of claim 1, wherein the quantum computing device comprises a qubit-based quantum computing device, and wherein the quantum operation comprises a qubit evolution, a qubit operation, a qubit gate operation, or a single-qubit gate operation.

13. A computing device, comprising:
a memory device to store computer-readable instructions thereon; and
at least one processing device configured through execution of the computer-readable instructions to:
derive noise cancellation conditions that are to be satisfied to define a corrective control signal that will cancel different noise types associated with performing a quantum operation when the corrective control signal is used to drive the quantum operation;
construct a space curve that satisfies the noise cancellation conditions in a multidimensional space, the space curve being representative of the corrective control signal; and
define the corrective control signal based on the space curve.

14. The computing device of claim 13, wherein the different noise types comprise a multiplicative noise type.

15. The computing device of claim 13, wherein the different noise types comprise transverse dephasing noise.

16. The computing device of claim 13, wherein the different noise types comprise control field noise.

17. The computing device of claim 13, wherein the noise cancellation conditions comprise a geometric condition that the space curve be a closed curve.

18. The computing device of claim 13, wherein the noise cancellation conditions comprise a geometric condition where a derivative of the space curve satisfies a zero-area condition.

19. A computing system, comprising:
a computing device configured to define a control signal that is to be implemented to perform a quantum operation, the control signal being defined to cancel different noise types associated with the quantum operation; and
a quantum computing device configured to perform the quantum operation based on the control signal, wherein the control signal cancels the different noise types during the quantum operation.

20. The computing system of claim 19, wherein the computing device is configured to define the control signal using a space curve quantum control process, the space curve quantum control process comprising:
deriving noise cancellation conditions that are to be satisfied to define the control signal;
constructing a space curve that satisfies the noise cancellation conditions in a multidimensional space, the space curve being representative of the control signal; and
defining the control signal based on the space curve.
